(19) United States
(12) Patent Application Publication
(10) Pub. No.: US 2021/0255413 A1
(43) Pub. Date: Aug. 19, 2021

(54) JACKET REMOVAL TOOL FOR FIBER OPTIC CABLES

(71) Applicant: CommScope Technologies LLC, Hickory, NC (US)

(72) Inventors: Clair IBURG, Rosemount, MN (US); Mandy Lea TRNKA, Lonsdale, MN (US)

(21) Appl. No.: 17/173,664

(22) Filed: Feb. 11, 2021

Related U.S. Application Data
(60) Provisional application No. 62/976,902, filed on Feb. 14, 2020.

(51) Int. Cl. G02B 6/44; B25F 1/00; G02B 6/25

(52) U.S. Cl. CPC G02B 6/4497; B25F 1/04; G02B 6/25; B25F 1/006

(57) ABSTRACT

The present disclosure relates to a handheld tool for scoring a jacket of a fiber optic cable. The handheld tool includes a U-shaped channel seat for supporting the fiber optic cable and a scoring head configured to support a cutting blade. The cutting blade can be fixed to the scoring head by a fastener and can be adjusted by utilizing a set screw. A blade setting block can be used to calibrate or adjust the cutting blade position prior to the operation of scoring the jacket of the fiber optic cable.

### TECHNICAL FIELD

The present disclosure relates to tools and methods for removing jackets of fiber optic cables.

### BACKGROUND

A variety of cables are commonly used for telecommunications and generally include outer jackets of plastic material. It is necessary to cut away the cable jacket at the cable end in preparation for connections, such as splices or connectorization. General purpose utility, craft or pocket knives are sometimes used for stripping off protective jackets of cables. While these general purpose cutting tools may have been used for this purpose, they can be tedious and may pose a risk of personal injury to the operator or unwanted damage to the underlying fiber.

In view of the foregoing, there is a continued need for tools and methods that remove jackets of a fiber optic cable.

### SUMMARY

One aspect of the present disclosure relates to a tool that enables a cutting depth of a blade to be set prior to scoring a fiber optic cable.

In certain examples, the tool may include a first handle member, a second handle member attached to the first handle member at a pivot location, a cutting blade, and optionally a blade setting block. The first and second handle members of the tool can be biased in a direction toward one another at the cutting end of the tool where the cutting blade is located by a spring element or biasing member when a user squeezes the tool. The blade setting block may include an extension member that has a diameter sized similarly to a fiber optic cable. The extension member may vary in size based on the diameter and jacket thickness of the fiber optic cable to be processed. When the blade setting block is mounted to the tool, the extension member can be inserted into a channel seat defined by the first handle member. When the blade is secured to the second handle member, the tool can be set at an initial cutting depth by the extension member. This allows a user to determine an initial cutting depth of the blade prior to scoring a jacket of a fiber optic cable. The blade setting feature of the tool helps to reduce the risk of a user cutting too deep into the jacket where optical fibers inside of the jacket may be damaged.

Another aspect of the present disclosure relates to a mechanical element, such as a screw, for use with the tool. The mechanical element may be utilized for making minor adjustments to the blade position once it is determined that the score line is either too deep or too shallow.

In one example, the mechanical element such as the screw may be turned as needed to allow for a change in the blade depth.

The extension member of the blade setting block can be reinserted into the channel seat to press against the blade against the mechanical element. Once inserted, the extension member can push the blade up against the mechanical element which sets a new cutting depth that can be tested on the cable jacket for an appropriate depth cut of the jacket. This adjustment method can be repeated as needed before finding the correct amount of the scoring the jacket of the fiber optic cable.

These and other features and advantages will be apparent from a reading of the following detailed description and a review of the associated drawings. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of an example tool including a first handle member, a second handle member, and a blade setting block in accordance with the principles of the present disclosure;

FIG. 2 is a right side view of the tool of FIG. 1;

FIG. 3 is a left side view of the tool of FIG. 1;

FIG. 4 is a bottom perspective view of the tool of FIG. 1;

FIG. 5 is a perspective view of the tool of FIG. 1 with the blade setting block removed;

FIG. 6 is a bottom view of the tool of FIG. 5;

FIG. 7 is an exploded view of the tool of FIG. 1;

FIG. 8 is an exploded view of the tool of FIG. 7;

FIG. 9 is another example first handle member in accordance with the principles of the present disclosure;

FIG. 10 is another example first handle member in accordance with the principles of the present disclosure; and

FIG. 11 is another example first handle member in accordance with the principles of the present disclosure.

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

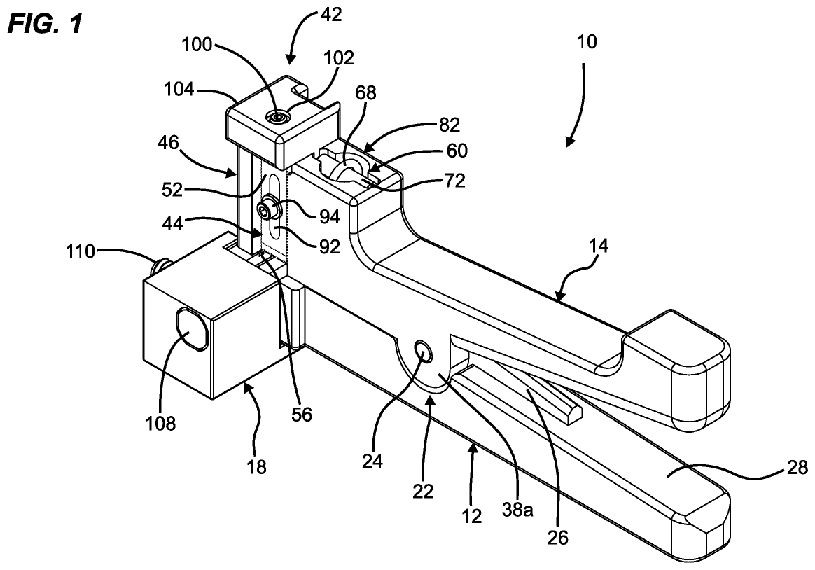

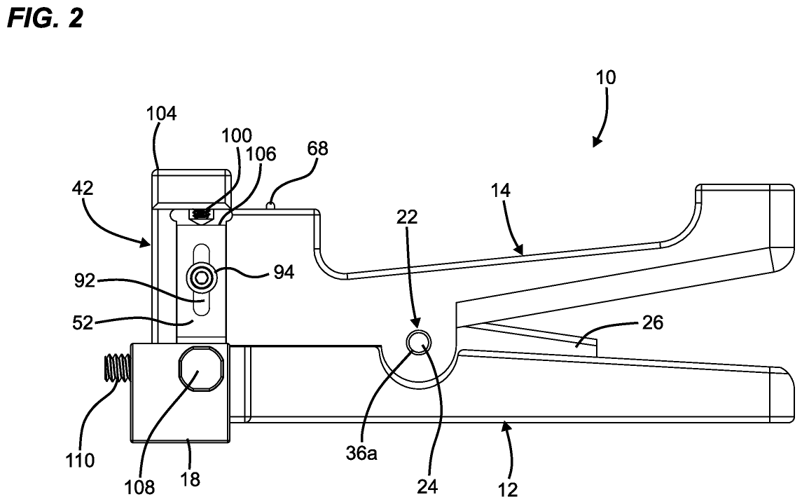

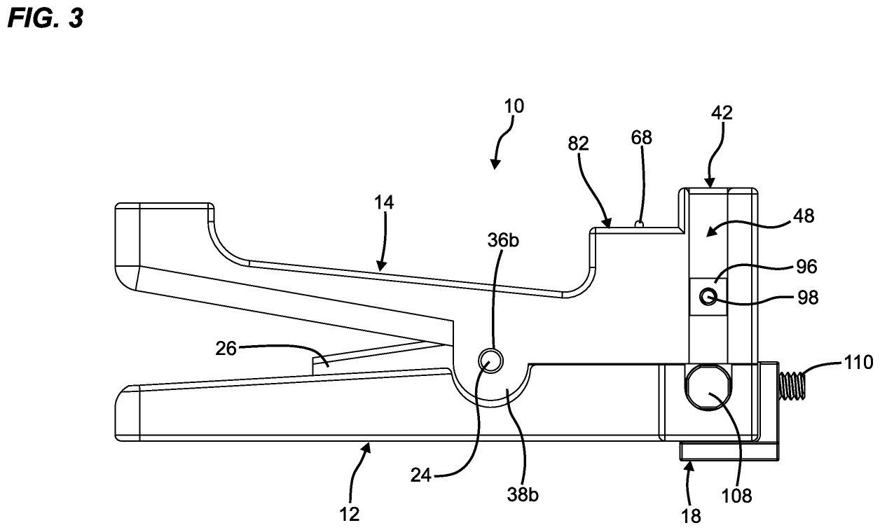

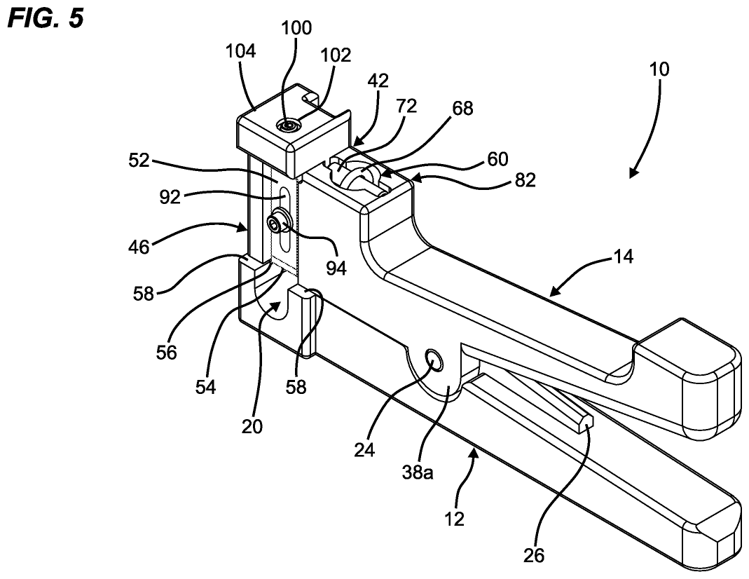

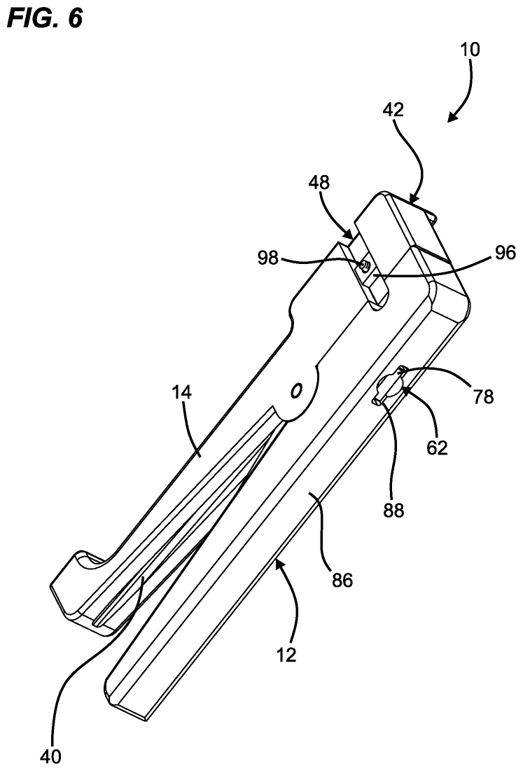

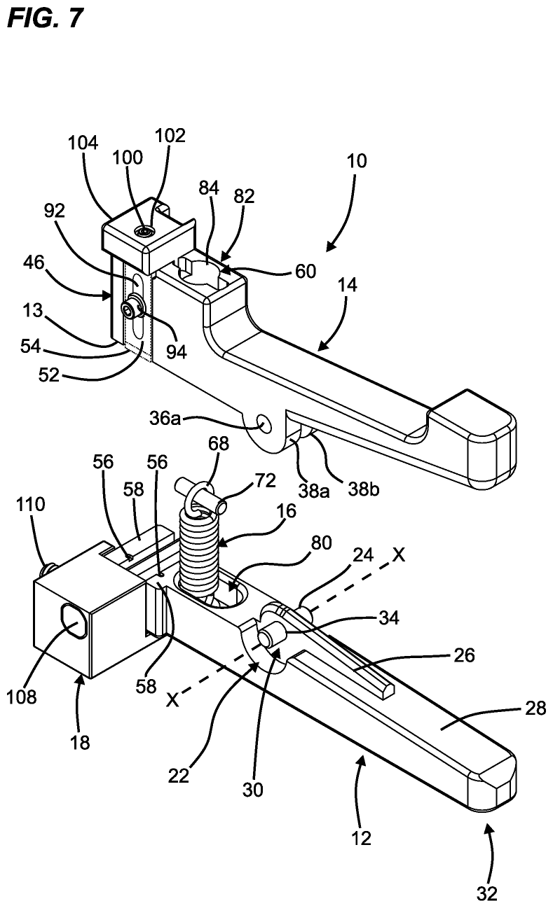

An example tool 10 for scoring a jacket of a fiber optic cable is depicted in FIGS. 1-8. In one example, the tool 10 is a handheld tool. The handheld tool 10 can include a first handle member 12, a second handle member 14, a biasing member 16 (see FIG. 7), and a blade setting block 18. The tool 10 is placed around a cable with a jacket portion that is to be removed, and then the tool 10 is rotated a sufficient number of times to score the jacket, which allows the jacket portion to be manually removed by the user without damaging the inner optical fiber or fibers.

The first handle member 12 defines a channel seat 20 for side-load reception of a fiber optic cable (not shown). The channel seat 20 can define a U-shape is some examples. In certain examples, the channel seat 20 of the first handle member 12 can have an inner diameter (side to side) of about 6 mm (millimeters) corresponding to a fiber optic cable, although alternatives are possible. In certain examples, the channel seat 20 of the first handle member 12 can have an inner diameter of about 8 mm (millimeters) corresponding to a fiber optic cable, although alternatives are possible. In certain examples, the channel seat 20 of the first handle member 12 can have an inner diameter of about 10 mm (millimeters) corresponding to a fiber optic cable, although alternatives are possible. In certain examples, the channel seat 20 of the first handle member 12 can have an inner diameter of about 12 mm (millimeters) corresponding to a fiber optic cable, although alternatives are possible. In certain examples, the channel seat 20 of the first handle member 12 can have an inner diameter of about 14 mm (millimeters) corresponding to a fiber optic cable, although alternatives are possible.

The second handle member 14 can be pivotally attached to the first handle member 12 at a pivot location 22 by a pivot pin 24. The handheld tool 10 can have a length that enables the first and second handle members 12, 14 to be gripped comfortably in a user's hand for squeezing.

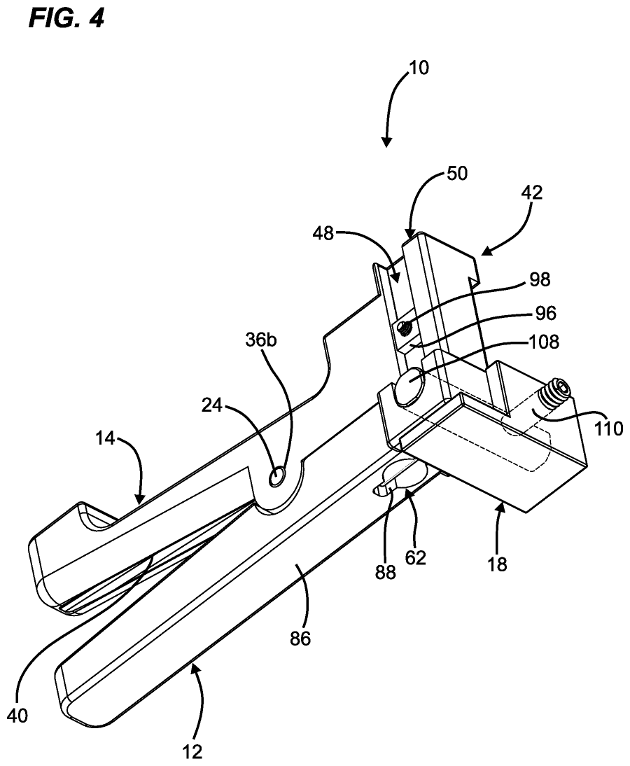

The first handle member 12 includes a rib 26 that projects upwardly from a top surface 28 of the first handle member 12. The rib 26 can have a contoured end 30 that tapers toward a distal end 32 of the first handle member 12. The contoured end 30 defines an opening 34 (see FIG. 7) to receive the pivot pin 24. The pivot pin 24 can pass through respective openings 36a, 36b defined in first and second legs 38a, 38b of the second handle member 14 to fix the first and second handle members 12, 14 together for pivotal movement about a pivot pin axis x-x. The second handle member 14 can define a slot 40 (see FIG. 4) for receiving the rib 26 of the first handle member 12 when the first and second handle members 12, 14 are squeezed toward one another.

The second handle member 14 includes a scoring head 42 that defines a first recessed wall 44 located at a first side 46 of the scoring head 42 and a second recessed wall 48 located at a second side 50 of the scoring head 42. The first recessed wall 44 can be adapted to support a cutting blade 52 longitudinally positioned therein. The cutting blade 52 can be configured for scoring circumferentially a jacket of a fiber optic cable when the fiber optic cable is positioned in the channel seat 20. In some examples, the cutting blade 52 has three side edges, two parallel edges and one perpendicular edge perpendicular to the two parallel edges. The cutting edge itself can be linear, or convexly curved in some examples.

When the first and second handle members 12, 14 are pivotally connected, the first recessed wall 44 of the scoring head 42 of the first handle member 12 opposes the channel seat 20 of the first handle member 12. When the cutting blade 52 is positioned within the first recessed wall 44, a bottom edge portion 54 of the cutting blade 52 can project toward or into the channel seat 20. The first handle member 12 can define grooves 56 (e.g., cutouts) (see FIG. 7) on opposite, upper surfaces 58 of the channel seat 20 for receiving the bottom edge portion 54 of the cutting blade 52. The upper surfaces 58 can extend along opposing sides of the channel seat 20 to provide an engagement surface for an abutment end 13 of the scoring head 42 when the first and second handle members 12, 14 are in a closed position for cutting the jacket.

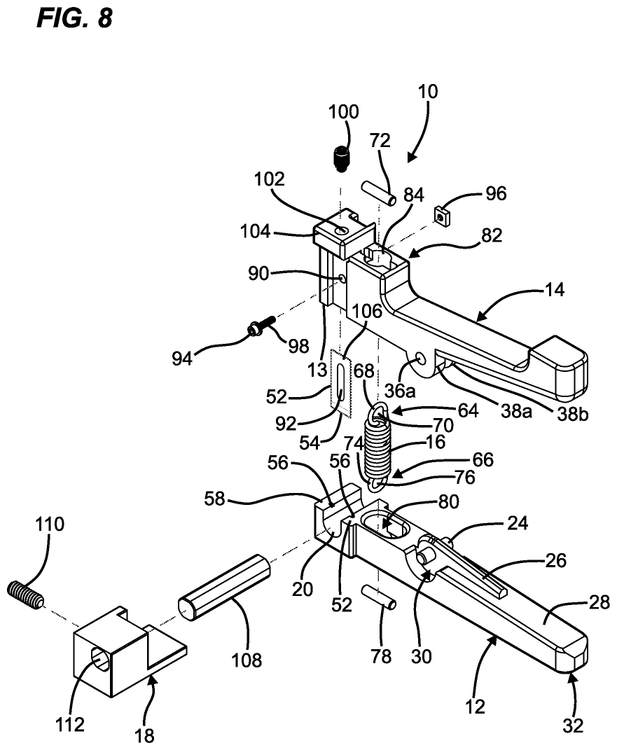

Referring to FIGS. 7-8, the biasing member 16 can be mounted between the pivot location 22 and the scoring head 42 for biasing the proximal ends of the first and second handle members 12, 14 toward a closed position such that when the scoring head 42 is raised relative to the channel seat 20, the biasing member seeks to close the tool when the handle members are released by the user. In certain examples, the biasing member 16 includes a coil spring, although alternatives are possible. In certain examples, the biasing member 16 can include a leaf spring, although alternatives are possible.

The biasing member 16 can be affixed to the first handle member 12 at a first spring fixation location 60 (see FIG. 1) and to the second handle member 14 at a second spring fixation location 62 (see FIG. 4.). In certain examples, the biasing member 16 includes a first end 64 and an opposite second end 66. The first end 64 of the biasing member 16 can include a first ring 68 that defines a first opening 70 for receiving a first spring supporting pin 72. The second end 66 of the biasing member 16 can include a second ring 74 that defines a second opening 76 for receiving a second spring supporting pin 78. The second end 66 of the biasing member 16 can be mounted within a cavity 80 defined in the first handle member 12.

In certain examples, the scoring head 42 of the second handle member 14 includes a top surface 82 that defines a first cutout 84 sized and shaped for receiving the first spring supporting pin 72 to anchor the first end 64 of the biasing member 16 within the second handle member 14 adjacent to the scoring head 42. The first handle member 12 includes a bottom surface 86 that defines a second cutout 88 sized and shaped for receiving the second spring supporting pin 78 to anchor the second end 66 of the biasing member 16 to the first handle member 12. The biasing member 16 acts to move the second handle member 14 relative to the first handle member 12. When the handheld tool 10 is squeezed, the abutment end 13 of the scoring head 42 can be raised from the upper surfaces 58 of the channel seat 20 of the first handle member 12. A fiber optic cable can be positioned into the channel seat 20. When the load on the handheld tool 10 is removed, i.e., when the first and second handle members 12, 14 are no longer pressed toward one another by the user, the abutment end 13 moves towards and preferably engages the upper surfaces 58 of the channel seat 20 such that the cutting blade 52 positioned in the first recessed wall 44 can press against a fiber optic cable positioned within the channel seat 20. Once the tool 10 is placed around a cable, the tool is rotated at least once around the cable, and preferably a few times around the cable to cut into the jacket to facilitate jacket removal.

The scoring head 42 can define a fastener opening 90 that extends between the first and second recessed walls 44, 48 of the scoring head 42. The cutting blade 52 can define a longitudinal slot 92 that can be aligned with the fastener opening 90 of the scoring head 42. A fastener 94 can be received within the longitudinal slot 92 of the cutting blade 52 for securing the cutting blade 52 within the first recessed wall 44 of the scoring head 42. The longitudinal slot 92 of the cutting blade 52 can be aligned with the fastener opening 90 such that when the fastener 94 is mounted, the fastener 94 extends through the fastener opening 90 from the first side 46 of the scoring head 42 to the second side 50 of the scoring head 42. The cutting blade 52 slides relative to fastener 94 within the longitudinal slot 92 when the fastener 94 is loosened so that the cutting blade 52 can be positioned at a desired position relative to the channel seat 20 of the first handle member 12.

The handheld tool 10 can further include a nut 96 adapted to receive a shank portion 98 of the fastener 94 when the fastener 94 is threaded into the fastener opening 90 through the second recessed wall 48 of the scoring head 42. The nut 96 can be seated in the second recessed wall 48 to limit turning of the nut 96 as the fastener 94 is threaded into the fastener opening 90 to fix the cutting blade 52.

An adjustment screw 100 can be received within an aperture 102 defined by an upper flange 104 of the scoring head 42. The adjustment screw 100 can be adapted to engage a top edge portion 106 of the cutting blade 52 such that when the adjustment screw 100 is turned, adjustments can be made to the position of the cutting blade 52. That is, the adjustment screw 100 can be utilized to set the cutting blade 52 at a depth optimized for scoring a jacket of a fiber optic cable. For example, the adjustment screw 100 can be rotated as needed for large or small adjustments. In some cases, no more than a half turn or a quarter turn may be done depending on the slight adjustments needed to set the cutting depth of the cutting blade 52, although alternatives are possible. For the cable preparation and the jacket removal, it is desired that the cutting blade not cut too deep all the way through the jacket where an inner fiber could get damaged, such as by cutting all the way through the fiber coating and causing a nick or scratch on the glass of the fiber (the cladding). If the jacket is not cut enough, the portion to be removed will not separate from the cable in some cases. If the jacket is properly scored, the jacket portion to be removed will separate from the jacket portion to be kept, by pulling on the jacket and/or bending the jacket portion still over the cable back and forth without over-bending the cable, until the jacket portion separates.

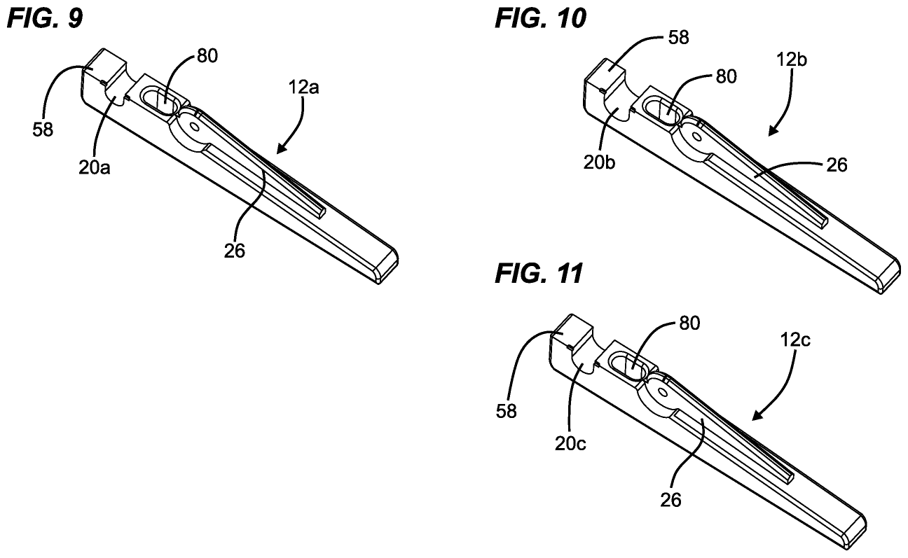

A method of scoring and/or removing an outer insulation jacket of a fiber optic cable with the tool 10 will be described in greater detail. The handheld tool 10 can be used to score the outer jacket circumferentially such that the jacket can be removed from the fiber optic cable. As depicted in FIGS. 9-11, a user may select a tool 10 for a desired cable to be processed with a first handle member 12a-12c which channel seats 20a-20c have different diameters based on a diameter size of a fiber optic cable. That is, the handheld tool 10, can have a first handle member 12 in which the diameter of the channel seat 20 can vary in size from 6 mm to 14 mm to accommodate a respective fiber optic cable similarly sized. For example, FIG. 9 depicts a first handle member 12a that includes a channel seat 20a configured for an 8 mm fiber optic cable. FIG. 10 depicts a first handle member 12b that includes a channel seat 20b configured for a 14 mm fiber optic cable. FIG. 11 depicts a first handle member 12c that includes a channel seat 20c configured for a 12 mm fiber optic cable. In the illustrated embodiments, the first handle members 12a-12c can be assembled with and used with identically constructed second handle members 14, although such is not required.

When the handheld tool 10 is squeezed, the scoring head 42 including the cutting blade 52 can be lifted away from the channel seat 20, 20a, 20b, 20c exposing the upper surfaces 58. A fiber optic cable can be side loaded for insertion into the channel seat 20, 20a, 20b, 20c. When the compression load on the handheld tool 10 is relieved, the scoring head 42 can be lowered back down such that the abutment end 13 is close to or engages the upper surfaces 58 about the channel seat 20. The bottom edge portion 54 of the cutting blade 52 can first contact the outer jacket. The handheld tool 10 can be rotated, for example one or more revolutions, such that the cutting blade 52 penetrates into the jacket to score only the jacket circumferentially without damaging the inner fiber(s). The cutting blade 52 can cut into a jacket of a fiber optic cable to a depth set by the fastener 94. The cutting blade 52 can ride up and down the fastener 94. That is, the cutting blade 52 can be moved linearly relative to the fastener 94 positioned in the longitudinal slot 92. If the cutting depth is not sufficient to penetrate the jacket, it will be appreciated that the cutting depth of the cutting blade 52 can be set easily, by slightly rotating the first screw 100 as will be described below.

In accordance with aspects of the present disclosure, the depth of the cutting blade 52 can be set prior to first cutting a fiber optic cable. That is, the blade setting block 18 can include an extension member 108 roughly sized similarly to a diameter of a fiber optic cable. It will be appreciated that the fiber optic cable can vary in size and jacket thickness. As such, the blade setting block 18 with the extension member 108 can be selected based on the diameter size of a corresponding fiber optic cable. In the example, the extension member 108 is generally an octagonal-shaped cylinder, although alternatives are possible. In certain examples, the extension member 108 can be supported in the blade setting block 18 by a second screw 110. That is, when the extension member 108 is positioned within an aperture 112 defined in the blade setting block 18, the second screw 110 can be screwed within the blade setting block 18 to hold the extension member 108 in place. In certain examples, the extension member 108 may be integral with (e.g., formed in one seamless piece with) or coupled to the blade setting block 18. In certain examples, the blade setting block 18 and the extension member 108 include a plastic material. In certain examples, the blade setting block 18 with the separate extension member 108 allows for more than one side of the extension member 108 to be used as each side wears out. Also, an opposite end can be used as the first end wears out. In these cases, the extension member 108 is removed from blade setting block 18, and then repositioned in aperture 112.

The diameter of the extension member 108 can vary, for example, between 6 mm and 14 mm, or more or less, depending on the user's needs. The desired size extension member 108 of the blade setting block 18 may be inserted into the corresponding sized channel seat 20. The fastener 94 can be loosely positioned within the longitudinal slot 92 of the cutting blade 52 such that the bottom edge portion 54 of the cutting blade 52 can be moveable relative to the extension member 108 of the blade setting block 18 once inserted into the channel seat 20 to place the cutting blade 52 in an initial position. Once the cutting blade 52 is in position, the fastener 94 can be tightened to secure the cutting blade 52 in place. The blade setting block 18 may be removed from the handheld tool 10 such that the cutting blade 52 may be tested on a fiber optic cable. Once a fiber optic cable is inserted into the channel seat 20, the handheld tool 10 can be rotated 360 degrees several times to circumferentially score a jacket of a fiber optic cable. If the scoring line is deep enough, the jacket can be separated and removed by pulling and/or bending the fiber optic cable at the score line to get the jacket portion to separate and come off.

In some examples, an adjustment to the cutting blade 52 may be needed if the score line is not deep enough or if the score line is too deep. If either occurs, the fiber optic cable can be removed from the handheld tool 10 to re-set the cutting blade 52. The fastener 94 can be loosened after which the screw 100 can be slightly turned to allow the cutting blade 52 to be lowered or raised. The blade setting block 18 can be re-inserted into the channel seat 20 such that the extension member 108 forces the cutting blade 52 up against the screw 100 such that contact of the screw 100 with the top edge portion 106 of the cutting blade 52 provides the adjustment to the cutting blade 52 to be either deeper or shallower. The fastener 94 can then be tightened to lock the cutting blade 52 in the new position. The blade setting block 18 can be removed and the fiber optic cable reinserted into the channel seat 20 of the handheld tool 10 to try the score operation again. This process can be repeated as needed to ensure a proper cutting depth without penetrating past the jacket to the fiber of the cable.

From the forgoing detailed description, it will be evident that modifications and variations can be made without departing from the spirit and scope of the disclosure.

What is claimed is:

1. A handheld tool for scoring a jacket of a fiber optic cable, the handheld tool comprising:
a first handle member that defines a U-shaped channel seat for side-load reception of the fiber optic cable;
a second handle member pivotally attached to the first handle member at a pivot location, the second handle member having a scoring head that defines a first recessed wall for supporting a cutting blade positioned therein, the first recessed wall opposing the channel seat of the first handle member such that when the cutting blade is positioned within the first recessed wall, a bottom edge portion of the cutting blade is configured to project toward the channel seat of the first handle member for scoring circumferentially the jacket when the fiber optic cable is positioned in the channel seat;
the scoring head defining a fastener opening for receiving a fastener that extends between first and second sides of the scoring head for securing the cutting blade in the first recessed wall at the first side of the scoring head, and the cutting blade defining a longitudinal slot that aligns with the fastener opening of the scoring head, wherein the cutting blade is movable up and down relative to the fastener to secure the cutting blade at a desired position relative to the channel seat of the first handle member;
a biasing member mounted between the pivot location and the scoring head for biasing the scoring head toward a closed position relative to the channel seat, the biasing member being affixed to the first handle member at a first spring fixation location and to the second handle member at a second spring fixation location; and
a screw positioned within an aperture defined in an upper flange of the scoring head, the screw being adapted to set the cutting blade at a depth optimized for scoring the jacket.

2. The handheld tool of claim 1, wherein the biasing member includes a first end having a first ring defining a first opening for receiving a first spring supporting pin.

3. The handheld tool of claim 2, wherein the biasing member includes an opposite second end having a second ring defining a second opening for receiving a second spring supporting pin.

4. The handheld tool of claim 2, wherein the scoring head of the second handle member includes a top surface that defines a first cutout for receiving the first spring supporting pin to anchor the first end of the biasing member to the scoring head.

5. The handheld tool of claim 4, wherein the first handle member includes a bottom surface that defines a second cutout for receiving the second spring supporting pin to anchor the second end of the biasing member to the first handle member.

6. The handheld tool of claim 1, wherein the first handle member defines grooves on opposite, upper surfaces of the channel seat for receiving the bottom edge portion of the cutting blade.

7. The handheld tool of claim 1, wherein the scoring head includes a second recessed wall at the second side.

8. The handheld tool of claim 7, further comprising a nut adapted to receive a shank portion of the fastener when the fastener is positioned into the fastener opening of the scoring head, the nut being seated in the second recessed wall to limit turning of the nut as the fastener is screwed.

9. The handheld tool of claim 1, further comprising a blade setting block including an extension member sized to correspond with the fiber optic cable, the extension member being adapted to mount in the channel seat of the first handle member to calibrate an initial scoring depth of the cutting blade prior to scoring the jacket of the fiber optic cable.

10. The handheld tool of claim 1, wherein the channel seat of the first handle member has an inner diameter of 6 mm (millimeters) corresponding to the fiber optic cable.

11. The handheld tool of claim 1, wherein the channel seat of the first handle member has an inner diameter of 8 mm (millimeters) corresponding to the fiber optic cable.

12. The handheld tool of claim 1, wherein the channel seat of the first handle member has an inner diameter of 10 mm (millimeters) corresponding to the fiber optic cable.

13. The handheld tool of claim 1, wherein the channel seat of the first handle member has an inner diameter of 12 mm (millimeters) corresponding to the fiber optic cable.

14. The handheld tool of claim 1, wherein the channel seat of the first handle member has an inner diameter of 14 mm (millimeters) corresponding to the fiber optic cable.

15. A handheld tool for scoring a jacket of a fiber optic cable, the handheld tool comprising:
a first handle member that defines a U-shaped channel seat for side-load reception of the fiber optic cable;
a second handle member pivotally attached to the first handle member at a pivot location, the second handle member having a scoring head that defines a first recessed wall for supporting a cutting blade positioned therein, the first recessed wall opposing the channel seat of the first handle member such that when the cutting blade is positioned within the first recessed wall, a bottom edge portion of the cutting blade is configured to project into the channel seat for scoring circumferentially the jacket when the fiber optic cable is positioned in the channel seat;
the scoring head defining a fastener opening for receiving a fastener that extends between first and second sides of the scoring head for securing the cutting blade in the first recessed wall at the first side of the scoring head, and the cutting blade defining a longitudinal slot that aligns with the fastener opening of the scoring head, wherein the cutting blade is movable up and down relative to the fastener to secure the cutting blade at a desired position relative to the channel seat of the first handle member;
a biasing member mounted between the pivot location and the scoring head for biasing the scoring head to an open position relative to the channel seat, the biasing member being affixed to the first handle member at a first spring fixation location and to the second handle member at a second spring fixation location; and
a blade setting block including an extension member sized to correspond with the fiber optic cable, the extension member being adapted to mount in the channel seat of the first handle member to calibrate an initial scoring depth of the cutting blade prior to scoring the jacket of the fiber optic cable.

16. The handheld tool of claim 15, wherein the biasing member includes a first end having a first ring defining a first opening for receiving a first spring supporting pin, and an opposite second end having a second ring defining a second opening for receiving a second spring supporting pin.

17. The handheld tool of claim 16, wherein the scoring head of the second handle member includes a top surface that defines a first cutout for receiving the first spring supporting pin to anchor the first end of the biasing member to the scoring head, and wherein the second handle member includes a bottom surface that defines a second cutout for receiving the second spring supporting pin to anchor the second end of the biasing member to the second handle member.

18. The handheld tool of claim 15, wherein an inner diameter of the channel seat of the first handle member is in the range of 6 mm to 14 mm.

19. A method of using a handheld tool for scoring a jacket of a fiber optic cable, the handheld tool comprising:
a first handle member that defines a U-shaped channel seat for side-load reception of the fiber optic cable;
a second handle member pivotally attached to the first handle member at a pivot location, the second handle member having a scoring head that defines a first recessed wall for supporting a cutting blade positioned therein, the first recessed wall opposing the channel seat of the first handle member such that when the cutting blade is positioned within the first recessed wall, a bottom edge portion of the cutting blade is configured to project toward the channel seat of the first handle member for scoring circumferentially the jacket when the fiber optic cable is positioned in the channel seat;
the scoring head defining a fastener opening for receiving a fastener that extends between first and second sides of the scoring head for securing the cutting blade in the first recessed wall at the first side of the scoring head, and the cutting blade defining a longitudinal slot that aligns with the fastener opening of the scoring head, wherein the cutting blade is movable up and down relative to the fastener to secure the cutting blade at a desired position relative to the channel seat of the first handle member;
a biasing member mounted between the pivot location and the scoring head for biasing the scoring head toward a closed position relative to the channel seat, the biasing member being affixed to the first handle member at a first spring fixation location and to the second handle member at a second spring fixation location; and
a screw positioned within an aperture defined in an upper flange of the scoring head, the screw being adapted to set the cutting blade at a depth optimized for scoring the jacket, the method comprising:
placing a blade setting block including an extension member sized to correspond with the fiber optic cable in the channel seat of the first handle member to calibrate an initial scoring depth of the cutting blade prior to scoring the jacket of the fiber optic cable;
adjusting the depth of the blade with the fastener and the screw; and
placing the blade setting block in the channel seat of the first handle member to set the new scoring depth of the cutting blade prior to scoring the jacket of the fiber optic cable a second time.

20. The method of claim 19, further comprising:
adjusting the depth of the blade a second time with the fastener and the screw; and
placing the blade setting block in the channel seat of the first handle member to set the new scoring depth of the cutting blade prior to scoring the jacket of the fiber optic cable a third time.
